(19) United States
(12) Patent Application Publication
(10) Pub. No.: US 2026/0034506 A1
(43) Pub. Date: Feb. 5, 2026

(54) ELECTROCHEMICAL SYSTEMS AND METHODS FOR CO2 CAPTURE AND RELEASE

(71) Applicant: Northwestern University, Evanston, IL (US)

(72) Inventors: Edward Hartley Sargent, Glencoe, WI (US); Zeyan Liu, Evanston, IL (US); Ke Xie, Evanston, IL (US)

(73) Assignee: Northwestern University, Evanston, IL (US)

(21) Appl. No.: 19/286,711

(22) Filed: Jul. 31, 2025

Related U.S. Application Data
(60) Provisional application No. 63/678,165, filed on Aug. 1, 2024.

(51) Int. Cl. B01D 53/32; B01D 53/62

(52) U.S. Cl. CPC B01D 53/326; B01D 53/62; B01D 2251/602; B01D 2257/504; B01D 2258/06

(57) ABSTRACT

Provided is a method comprising delivering CO₂ to a first electrode of an electrochemical cell, the first electrode in electrical communication with a second electrode and the first electrode comprising an electrosorbent material free of carbon atoms and comprising a metal; and applying a first electrical bias to the first electrode to induce a reduction reaction to capture the CO₂ on surfaces of the electrosorbent material. Electrochemical cells configured to capture and release CO₂ are also provided.

### CROSS-REFERENCE TO RELATED APPLICATION

The present application claims priority to U.S. provisional patent application No. 63/678,165 that was filed Aug. 1, 2024, the entire contents of which are incorporated herein by reference.

### BACKGROUND

Greenhouse gases (GHG) emission, particularly CO₂, have caused an increase in global temperature, leading to severe climate change. In this context, an aggressive scenario has been offered, targeting net-zero emission by 2060 to limit the global temperature increase to below 1.5° C. Within the portfolio of emission reduction plans, carbon capture and storage (CCS) technologies are assumed to account for 25% of the annual CO₂ emission of over 35 Gt. Direct air capture (DAC), in particular, plays an important role in the net-zero future by providing solution for decreasing the atmospheric CO₂ concentration and balancing the hard-to-avoid carbon emissions. However, current CCS technologies face challenges including cost, energy consumption, durability, and complexity in process engineering, and these challenges further escalate with lower CO₂ concentration and sensitivity to oxygen and humidity in DAC.

### SUMMARY

Provided are electrochemical methods for capturing CO₂ and, as desired, releasing the CO₂. Electrochemical cells for carrying out the methods are also provided.

The present disclosure includes an Example below demonstrating an electrochemical strategy for capturing and releasing CO₂ across a wide range of CO₂ concentrations (e.g., 0.04%-100%, by volume). In addition, tolerance of the strategy to oxygen is demonstrated, enabling use of the present methods for direct air capture applications. The electrochemical strategy involves use of an electrosorbent material (e.g., a metal oxide such as MnO₂), in which reduction and oxidation reactions of the electrosorbent material drive the mineralization (i.e., capture) and demineralization (i.e., release) of CO₂ on surfaces of the electrosorbent material. The performance of an illustrative electrified CO₂ mineralization/demineralization capture/release (eCO₂-MDCR) device using MnO₂ as the electrosorbent material is evaluated using various CO₂ concentrations targeting different application scenarios. CO₂-analyzer-coupled electrochemical testing and Operando Raman spectroscopy reveals that the highly potential dependent redox reactions of the manganese oxide simultaneously drive the mineralization (i.e., capture) and demineralization (i.e., release) of CO₂ on surfaces thereof. Notably, the strategy has successfully demonstrated CO₂ capture and release from ambient air at a low energy cost of 3.2 GJ/ton_{CO2} and a stable DAC cycling operation over 290 hours without noticeable loss in CO₂ capacity.

An embodiment 1 is provided for a method comprising delivering CO₂ to a first electrode of an electrochemical cell, the first electrode in electrical communication with a second electrode and the first electrode comprising an electrosorbent material free of carbon atoms and comprising a metal; and applying a first electrical bias to the first electrode to induce a reduction reaction to capture the CO₂ on surfaces of the electrosorbent material.

An embodiment 2 is according to embodiment 1, wherein the electrosorbent material is redox active at neutral pH and over a range of electrode potentials at which an electrolyte in the electrochemical cell does not undergo redox reactions, and further wherein the reduction reaction occurs in a solid phase.

An embodiment 3 is according to any of embodiments 1-2, wherein the CO₂ is captured by a binding moiety of the electrosorbent material, the binding moiety comprising the metal in its reduced form and covalently bound to an oxygen atom having an unpaired electron.

An embodiment 4 is according to any of embodiments 1-3, wherein the electrosorbent material is a metal oxide.

An embodiment 5 is according to embodiment 4, wherein the metal of the metal oxide is selected from Mn, Ti, V, Cr, Ni, Co, Cu, Fe, and combinations thereof.

An embodiment 6 is according to embodiment 4, wherein the transition metal oxide is MnO₂.

An embodiment 7 is according to any of embodiment 1-6, further comprising either applying a second electrical bias to the first electrode to induce an oxidation reaction to release captured CO₂ from the surfaces of the electrosorbent material of the first electrode; or applying the second electrical bias to the second electrode of the electrochemical cell, the second electrode comprising an electrosorbent material free of carbon atoms and comprising a metal, to induce an oxidation reaction to release captured CO₂ from surfaces of the electrosorbent material of the second electrode.

An embodiment 8 is according to embodiment 7, wherein the electrosorbent material of the first electrode and the electrosorbent material of the second electrode are the same type of electrosorbent material.

An embodiment 9 is according to any of embodiments 1-8, wherein the CO₂ is delivered at an amount of less than 1% by volume.

An embodiment 10 is according to any of embodiments 1-9, wherein the CO₂ is in air delivered to the first electrode.

An embodiment 11 is according to any of embodiments 1-10, wherein the electrochemical cell further comprises an electrolyte in contact with the first and second electrodes and the electrolyte is at neutral pH.

An embodiment 12 is according to any of embodiments 7-11, wherein the CO₂ is captured at a pH, at a temperature, and at a pressure, and the CO₂ is released at the same pH, at the same temperature, and at the same pressure.

An embodiment 13 is according to any of embodiments 7-11, wherein no feed gas, other than a feed gas to deliver CO₂, is used to release captured CO₂.

An embodiment 14 is according to any of embodiment 1-13, wherein the electrochemical cell comprises one or more separators positioned between the first and second electrodes.

An embodiment 15 is according to embodiment 14, wherein the one or more separators are not bipolar membranes and are not anion exchange membranes.

An embodiment 16 is according to any of embodiments 14-15, wherein the electrochemical cell comprises one separator between the first electrode and the second electrode, a gas inlet for delivery of the CO₂ to the first electrode, an electrolyte inlet for delivery of the electrolyte to the second electrode, and a gas outlet for release of CO₂ from the first electrode.

An embodiment 17 is according to any of embodiments 14-16, wherein the electrochemical cell comprises a first separator and a second separator positioned between the first and second electrodes and defining a channel therebetween, a gas inlet for delivery of CO₂ to the first electrode, an electrolyte inlet for delivery of the electrolyte to the channel, and a gas outlet for release of CO₂ from the second electrode.

An embodiment 18 is an electrochemical cell configured to capture and release CO₂, the electrochemical cell comprising: a first electrode comprising an electrosorbent material free of carbon atoms and comprising a metal; a second electrode in electrical communication with the first electrode, the second electrode comprising the electrosorbent material; one or more separators positioned between the first and second electrodes; and a protic electrolyte at neutral pH in fluid communication with the first and second electrodes.

An embodiment 19 is according to embodiment 18, wherein the one or more separators are not bipolar membranes and are not anion exchange membranes.

An embodiment 20 is according to any of embodiments 18-19, wherein the electrosorbent material is a metal oxide and the metal of the metal oxide is selected from Mn, Ti, V, Cr, Ni, Co, Cu, Fe, and combinations thereof.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIGS. 1A-1D. Schematic illustration of an illustrative electrified CO₂ mineralization/demineralization capture/release (eCO₂-MDCR) device. (FIG. 1A) Illustration of an existing indirect bulk pH-swing device (left image, prior art) which is by contrast to an illustrative reversible adsorption/mineralization device according to the present disclosure (right image). To capture CO₂ with acceptable kinetics, in the prior art device, CO₂ is captured in the form of CO₃²⁻ in solution (liquid phase) at basic pH, which consumes two OH⁻ and thus requires two electrons. By contrast, in the illustrative reversible CO₂ adsorption/mineralization device according to the present disclosure, only one electron per CO₂ is consumed and the capture/release takes place on surfaces of a solid metal oxide (e.g., MnO₂) at neutral pH. (FIG. 1B) The proposed direct surface mineralization CO₂ capture compared (bottom) to indirect bulk pH-swing CO₂ capture (top). (FIG. 1C) Pourbaix diagram analysis on transition metal oxides. It is noted that MnO₂ is a desirable candidate that meets the requirements of being dissolution resistant and redox active within the water stable potential region near neutral conditions. (FIG. 1D) DFT calculation of the *OCO₂H adsorption energy in the form of Mn—OCO₂H versus potential. It is noted that the free energy crossover at around 0.7 V indicates that the CO₂ capture and release may be controlled by the applied potential.

FIGS. 2A-2D. Proof-of-concept of the illustrative eCO₂-MDCR device and mechanism study with Operando Raman Spectroscopy. (FIG. 2A) Schematic of the illustrative eCO₂-MDCR device and the proposed reversible CO₂ mineralization capture and release mechanism. Note that only the working electrode was analyzed in the device, but the symmetric counter electrode can also conduct CO₂ capture and release simultaneously (see FIG. 6B). (FIG. 2B) Initial observation of highly potential dependent CO₂ capture and release, proving the feasibility of the strategy. The proposed mechanism and corresponding Raman Spectroscopy of (FIG. 2C) CO₂ capture and mineralization, and (FIG. 2D) CO₂ release and demineralization. Note that the Raman peak for Mn—OH was not observed, while a potential dependent increase/decrease in bicarbonate (Mn—OCO₂H) and then carbonate (Mn—OCO₂⁻) were observed during the capture/release process.

FIGS. 3A-3F. Flue gas capture performance of the illustrative eCO₂-MDCR device. The applied electrochemical current charging protocol (bottom curve), cell voltage profile (second curve from bottom), CO₂ molar flow rate (third curve from bottom), and accumulative coulombic efficiency (top curve) with feed gas CO₂ concentration of (FIG. 3A) 100% pure, (FIG. 3B) 10% simulating the flue gas from coal plant, and (FIG. 3C) 4% simulating the flue gas from a natural gas combined cycle power plant. (FIG. 3D) Peak coulombic efficiency with different feed gas CO₂ concentration derived from the ratio between the maximum CO₂ capture and release molar rate and the electron transfer charging rate. (FIG. 3E) Energy cost of the capture and release process with different feed gas CO₂ concentration derived from the net energy consumption and the quantity of CO₂ in each the capture or release process. (FIG. 3F) Productivity with different feed gas CO₂ concentration derived from the CO₂ captured and released quantity, cycle duration, and electrode loading.

FIGS. 4A-4F. Direct air capture performance of the illustrative eCO₂-MDCR device. (FIG. 4A) cyclic voltammetry curve under air and N₂. The identical shape indicates that the oxygen reduction reaction was not observed within the applied voltage range. (FIG. 4B) The applied electrochemical charging protocol (bottom curve), cell voltage profile (second curve from bottom), CO₂ molar flow rate (third curve from bottom), and accumulative coulombic efficiency (top curve) in a typical-IV to IV DAC cycle. (FIG. 4C) Corresponding peak coulombic efficiency and energy cost for capture and release processes in the −1V to IV DAC cycle. Optimization of protocol with stepped capture (FIG. 4D) and release (FIG. 4E) at a step of 0.2 V. (FIG. 4F) Comparison of energy cost and productivity (kinetics) of −1V to IV DAC and optimized-IV to 0.4V DAC protocol.

FIG. 5. Direct air capture durability evaluation of the illustrative eCO₂-MDCR device. The device was subjected to complete capture and release voltage cycles (around 1.4 hours per cycle) with continuous air flow. It is noted that the CO₂ release performance was stable throughout the 290 hours of testing, while the release to capture ratio gradually reached 100%, indicating a balance in carbon mass during stable operation.

FIG. 6A-6B. Illustrative eCO₂-MDCR devices. (FIG. 6A) asymmetric and (FIG. 6B) symmetric device architecture. In an illustrative operation mode for the symmetric device, when one side is operating to capture CO₂ with an input gas flow, the other side may be operating to release CO₂ without any input gas flow to provide highly concentrated CO₂ (e.g., ideally >95%). Some vacuum pumping may be used on the release side to remove any remaining air in the chamber before the release.

### DETAILED DESCRIPTION

Provided are methods for capturing CO₂, and as desired, releasing the captured CO₂. In an embodiment, such a method comprises delivering CO₂ to a first electrode of an electrochemical cell, the first electrode comprising an electrosorbent material; and applying a first electrical bias to the first electrode to induce a reduction reaction to capture CO₂ on surfaces of the electrosorbent material. The method may further comprise releasing the captured CO₂ by either applying a second electrical bias to the first electrode to induce an oxidation reaction to release captured CO₂ from the surfaces of the electrosorbent material or applying the second electrical bias to a second electrode of the electrochemical cell, the second electrode in electrical communication with the first electrode and comprising an electrosorbent material, to induce an oxidation reaction to release captured CO₂ from surfaces of the electrosorbent material of the second electrode.

The CO₂ delivered to the first electrode may be provided as a pure gas or as a gas mixture comprising the CO₂ along with one or more other gases, e.g., N₂, O₂. The gas mixture may comprise or consist of air. The amount of CO₂ being delivered may span a wide range, e.g., 100% (pure CO₂) to 0.04% (by volume). This includes an amount of CO₂ of no more than 20%, no more than 15%, no more than 10%, no more than 5%, or less than 1% (by volume), or a range between any of these values The CO₂ in the gas mixture may be, but need not be, humidified, i.e., some amount of H₂O may be present. In embodiments, the CO₂ is not humidified, i.e., no H₂O is present.

The first electrode comprises or consists of =an electrosorbent material. The electrosorbent material is a solid material that is capable of undergoing redox reactions (i.e., reduction and oxidation reactions) and capable of adsorbing CO₂ onto surfaces thereof. This may occur due to CO₂ reacting with an intermediate species of the redox reactions, the intermediate species comprising a binding moiety that binds (e.g., covalently) to CO₂.

Desirably, the electrosorbent material has additional properties. First, the electrosorbent material is desirably inorganic. This includes the electrosorbent material being free of carbon-hydrogen bonds, being free of carbon atoms, or both. Second, the electrosorbent material is desirably redox active over a range of electrode potentials that is within the stable redox potential window of an electrolyte being used in the electrochemical cell. This allows the electrolyte to remain electrochemically stable without undergoing oxidation or reduction reactions over the range of electrode potentials that the electrosorbent material is redox active. For aqueous electrolytes, this means the electrosorbent material is redox active at neutral pH and over a range of electrode potentials at which the aqueous electrolyte is electrochemically stable and does not undergo oxidation or reduction reactions such as water dissociation and oxygen reduction. By neutral pH, it is meant a pH in a range of from 6 to 8, including 7. Third, the electrosorbent material is desirably insoluble in the electrolyte being used in the electrochemical cell during operation of the electrochemical cell, i.e., the redox reactions occur in the solid phase rather than in a liquid phase. Redox reactions occurring in the solid phase encompass those occurring at an interface formed between the solid electrosorbent material and an electrolyte, including a liquid electrolyte such as an aqueous electrolyte. As described in the Example, below, Pourbaix diagram analysis and density functional theory (DFT) simulations may be used to identify suitable electrosorbent materials having the characteristics described above.

The electrosorbent material may be a metal oxide. Again, Pourbaix diagram analysis and DFT simulations may be used to identify suitable metal oxides having the characteristics described above. However, the metal oxide may be a transition metal oxide, MOx, wherein M is Mn, Ti, V, Cr, Ni, Co, Cu, or Fe. Mixed metal oxides may be used. Combinations of different types of metal oxides may be used. However, in embodiments, the metal oxide is MnO₂.

The electrosorbent material (e.g., metal oxide), which may be in powder form, may be provided as an ink. Such an ink may comprise or consist of other components such as a conductive material (e.g., carbon black), a binder (e.g., a sulfonated tetrafluoroethylene based fluoropolymer-copolymer), a solvent (e.g., an alcohol). The electrosorbent material (or ink comprising the electrosorbent material) may be coated onto a substrate. The substrate may be porous (e.g., carbon paper) so as to facilitate diffusion of the CO₂ therethrough and delivery of the CO₂ to the electrosorbent material of the first electrode. Such substrates may also be referred to as gas diffusion layers.

The electrochemical cell further comprises an electrolyte to provide ionic conductivity and prevent an electrical short. The electrolyte may be in fluid communication with the first and second electrodes so as to form an interface with each. The electrolyte may be a liquid or a solid (e.g., a solid hydrogel). Protic electrolytes may be used, e.g., aqueous electrolytes comprising or consisting of water and a salt. The salt may be an alkali metal salt, e.g., Na₂SO₄, NaCl, K₂SO₄, KCl, etc. The pH of the electrolyte may be neutral. This includes the electrolyte having a neutral pH during operation of the electrochemical cell, including during the reduction and oxidation reactions that capture CO₂ and release CO₂, respectively. Aprotic electrolytes and ionic liquid electrolytes are not required.

The second electrode of the electrochemical cell may also comprise or consist of the electrosorbent material. This includes embodiments in which the same type of electrosorbent material is used for both the first and second electrodes, e.g., MnO₂ is used for both the first and second electrodes.

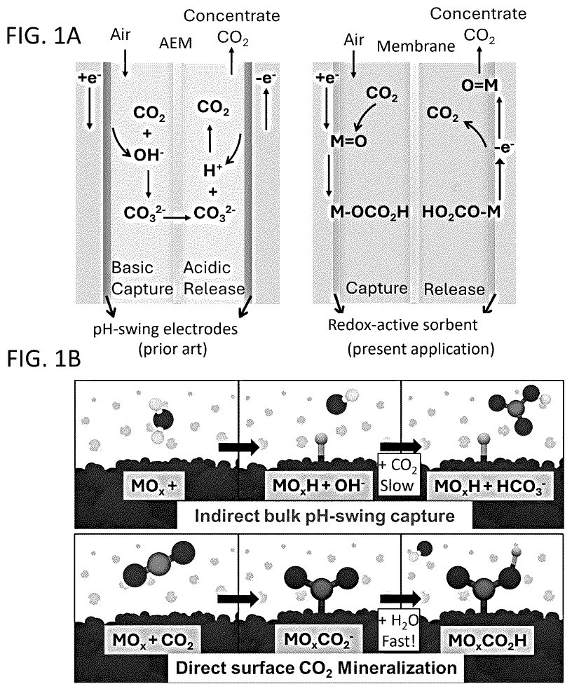

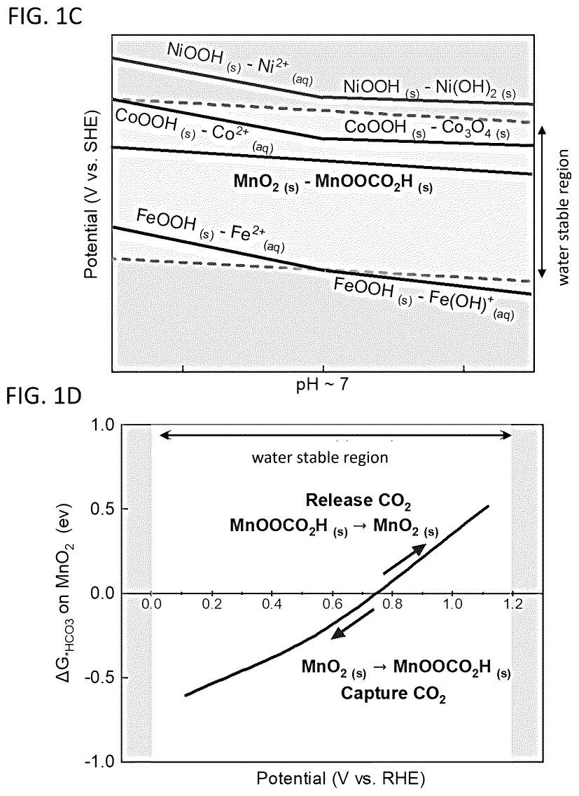

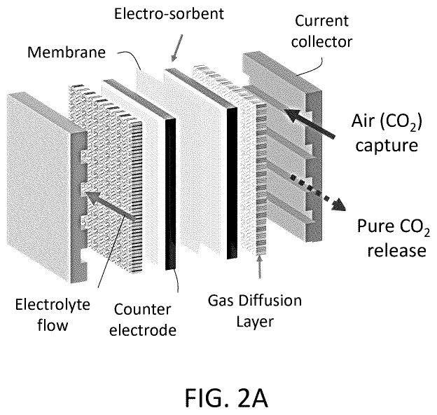

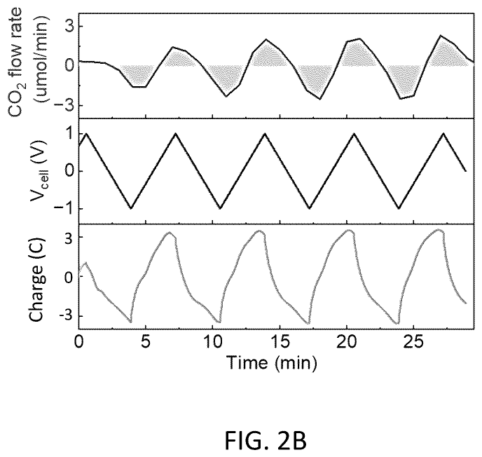

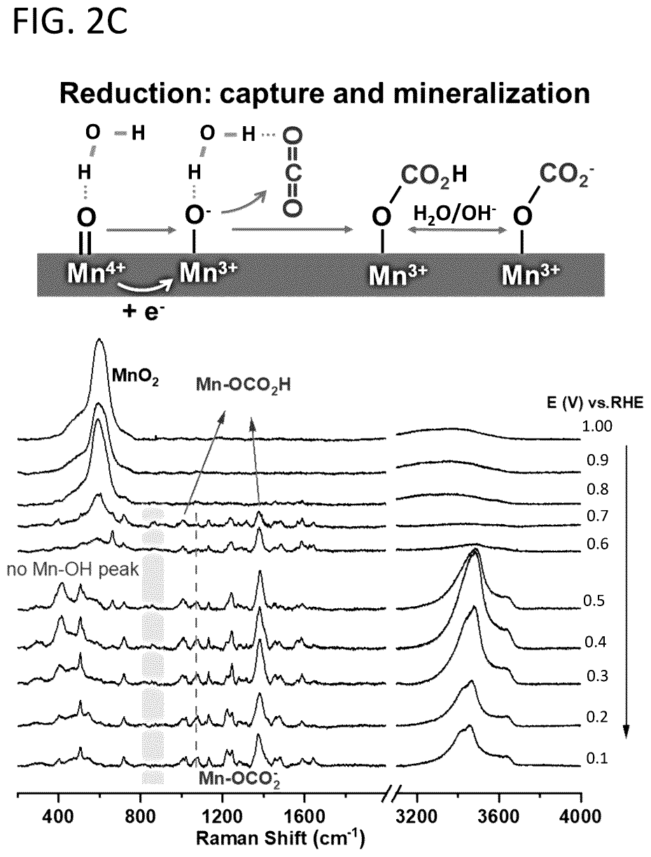

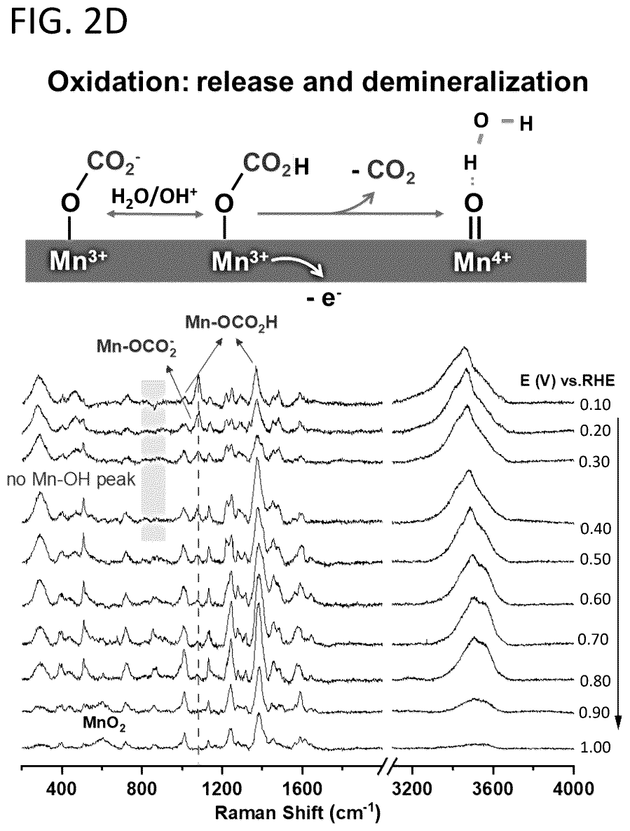

As noted above, in the present methods, a first electrical bias is applied to the first electrode to induce a reduction reaction. Without wishing to be bound to a particular theory, it is believed that the appropriate electrical bias induces the electrosorbent material, e.g., the metal of a metal oxide electrosorbent material, to undergo a reduction reaction and capture CO₂ by binding it onto surfaces of the electrosorbent material. With reference to FIGS. 1A (right image), 1B, and 2C, using MnO₂ as an illustrative electrosorbent material and an aqueous electrolyte at neutral pH, as an electrical bias is applied towards-1 V, it is believed the metal center Mn⁴⁺ is reduced to Mn³⁺, forming an intermediate species Mn³⁺O⁻ which reacts with CO₂ to form MnO—CO₂H and/or MnO—CO₂⁻ on surfaces of the electrosorbent material As shown in FIG. 2C, this reaction may be mediated by water. The binding moiety of the Mn³⁺O⁻ intermediate species is the oxygen atom with the unpaired electron covalently bound to the reduced Mn³⁺ atom. This reduction reaction of MnO₂ captures CO₂ on surfaces of the electrosorbent material in the form of bicarbonate/carbonate. Thus, the CO₂ capture mechanism of the present systems and methods is by contrast to the approach in some existing CO₂ capture/release systems such as that shown in FIG. 1A, left image, in which the reduction reaction requires basic pH (e.g., pH 14) and produces hydroxide; in the present systems/methods, the reduction reaction occurs at neutral pH and does not produce hydroxide. In addition, in some existing CO₂ capture/release systems, the bicarbonate/carbonate formation occurs in the liquid phase; in the present systems/methods, the bicarbonate/carbonate formation occurs in the solid phase on surfaces of the electrosorbent material.

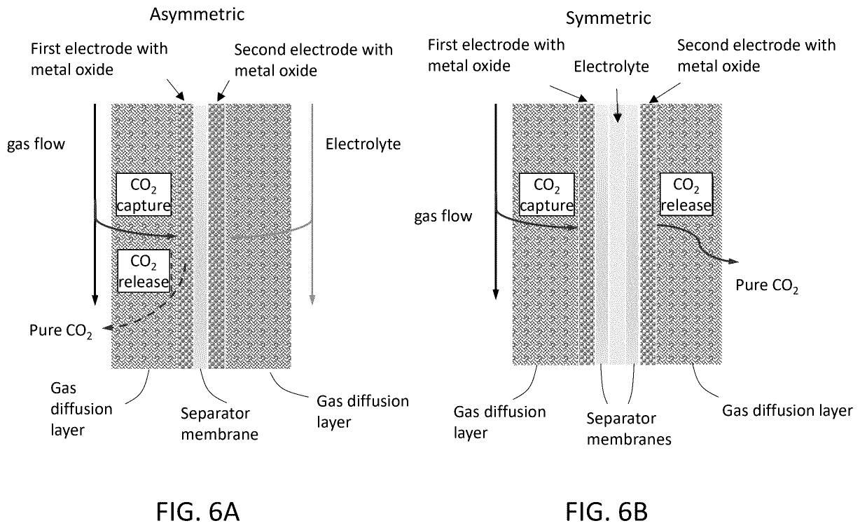

To release the captured CO₂ from the first electrode, a second electrical bias may be applied to induce an oxidation reaction. (Depending upon the particular configuration of the electrochemical device as further described below and in reference to FIGS. 6A-6B, the second electrical bias may be applied to the first electrode or to the second electrode.) Again, with reference to FIGS. 1A (right image), 1B, and 2C, using MnO₂ as an illustrative electrosorbent material and an aqueous electrolyte at neutral pH, as an electrical bias is applied towards +1 V, it is believed the metal center Mn³⁺ is oxidized to Mn⁴⁺ which induces the release CO₂ from surfaces of the electrosorbent material. Thus, the CO₂ release mechanism in the present systems and methods is by contrast to the approach in certain existing CO₂ capture/release systems as shown in FIG. 1A, left image, in which the oxidation reaction requires acidic pH (e.g., pH 0) and produces protons (or consumes hydroxide); in the present systems/methods, the oxidation reaction occurs at neutral pH and does not produce protons/consume hydroxide. In addition, in the existing CO₂ capture/release systems, release of CO₂ involves a liquid phase reaction of the bicarbonate/carbonate; in the present systems/methods, no such bicarbonate/carbonate reaction occurs and the CO₂ is released from the solid phase surfaces of the electrosorbent material.

In other existing electrochemical CO₂ capture/release systems, the reduction reaction occurs at a basic pH and involves intercalation of protons into the relevant electrode material while the oxidation reaction occurs at an acidic pH and involves deintercalation of protons from the relevant electrode material. Again, in the present systems and methods, the reduction and oxidation reactions occur at neutral pH and protons do not intercalate (deintercalated) into (out of) the electrosorbent material.

Additional differences of the present systems/methods as compared to existing CO₂ capture/release systems include one or more of the following: some existing CO₂ capture/release systems require anion exchange membranes to allow the bicarbonate/carbonate anions to pass therethrough, whereas, in the present systems/methods, bicarbonate/carbonate anions do not pass through a membrane/separator that may be present; some existing CO₂ capture/release systems require a feed gas for the oxidation reaction to produce the protons/consume the hydroxide and thus, release the CO₂, whereas no such feed gas is required in the present systems/methods; and some existing CO₂ capture/release systems necessarily produce impure CO₂ (e.g., a mixture of CO₂/H₂) whereas the present systems/methods are capable of releasing pure CO₂. Purity with respect to released CO₂ encompasses a released gas that is at least 95% (by volume) CO₂. This includes at least 96%, 97%, 98%, 99%, 100%, or a range between any of these values (by volume). These differences (as well as the other differences described throughout the present disclosure) distinguish the present systems/methods from those in U.S. Pat. No. 11,757,120.

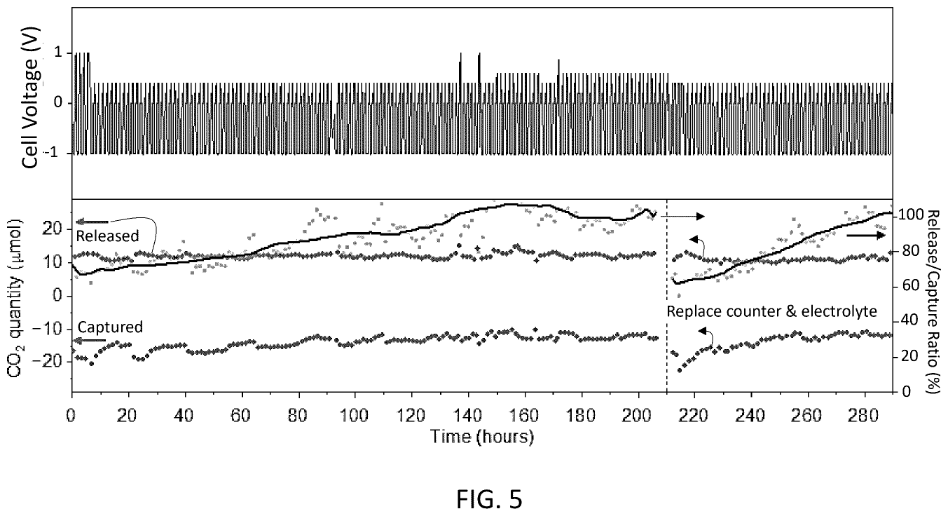

Conditions of the present methods, including the magnitude (and sign) of the electrical bias (including a range over which the electrical bias may be scanned), charging rate, electrical bias scanning profile (e.g., electrical bias continuously scanned or step scanned as in FIGS. 5D-5E), amount of electrosorbent material (e.g., metal oxide), amount of salt in the electrolyte, temperature, flow rate of CO₂ gas or gas mixture, etc. may be adjusted to achieve a desired peak Coulombic efficiency, energy cost, productivity, etc. In addition, these amounts may be independently selected to achieve desired values of these parameters for either CO₂ capture or CO₂ release. Regarding temperature, room temperature conditions may be used (e.g., from 20 to 25° C.). Regarding pH, as noted above, a neutral pH is generally used. Further regarding parameters such as temperature, pH, and pressure, whatever specific value is used, both CO₂ capture and CO₂ release are generally carried out at the same value. This distinguishes the present systems/methods from existing CO₂ capture/release systems involving a change (i.e., swing) in one or more of temperature, pH, and pressure.

The present methods may be carried out using an electrochemical device comprising the first electrode, the electrolyte, and the second electrode. Various configurations may be used, comprising additional components and/or making use of various arrangements of such components. Two illustrative configurations are shown in FIGS. 6A (asymmetric) and 6B (symmetric). In the asymmetric configuration shown in FIG. 6A, a separator (in this embodiment, a membrane) is positioned between a first electrode comprising a metal oxide (in this embodiment, MnO₂) and a second electrode which may also comprise the metal oxide. A gas inlet (not shown) delivers the CO₂ gas or gas mixture to the first electrode while an electrolyte inlet (not shown) delivers the electrolyte to the second electrode. In this embodiment, the reduction and oxidation reactions take place at the first electrode (as induced by the first and second electrical biases, respectively, applied to the first electrode) and CO₂ is released from the first electrode through a gas outlet (not shown). Asymmetric configurations are also shown in FIG. 1A (right image) and FIG. 2A.

In the symmetric configuration shown in FIG. 6B, first and second separators are positioned to define a channel through which the electrolyte may be delivered. The first separator is positioned adjacent to the first electrode comprising the metal oxide. The second separator is positioned adjacent to the second electrode which may also comprise the metal oxide. A gas inlet (not shown) delivers the CO₂ gas or gas mixture to the first electrode. In this embodiment, the reduction reaction takes place at the first electrode (as induced by the first electrical bias). The oxidation reaction takes place at the second electrode (as induced by the second electrical bias applied to the second electrode) and CO₂ is released from the second electrode through a gas outlet (not shown).

As shown in FIGS. 6A and 6B, in both configurations, the electrochemical device may comprise gas diffusion layers. The separator may be a membrane such as an ion-exchange membrane. However, the separator membrane is generally not a bipolar membrane. Also, as noted above, anion-exchange membranes could be used, but are not required. Thus, in embodiments, an anion-exchange membrane is not used. The separator may be a porous polymer membrane or a hydrogel electrolyte membrane. Porous polymer membranes such as those used as non-ionic battery separators may be used including polyethylene, polypropylene, or even cellulose films, including mixed cellulose ester. Hydrogel electrolyte membranes that are ionic (e.g., polyacrylic acid), nonionic (e.g., polyvinyl alcohol), or mixed may be used. The electrochemical devices shown in FIGS. 6A and 6B may further comprise current collector plates in electrical communication with the gas diffusion layers. However, as shown in FIGS. 6A and 6B (as well as in FIG. 1A (right image) and FIG. 2A, the present electrochemical devices (and systems comprising such electrochemical devices) do not require any feed gas for the oxidation reaction to release CO₂ and thus, need not comprise any gas inlet for such a feed gas.

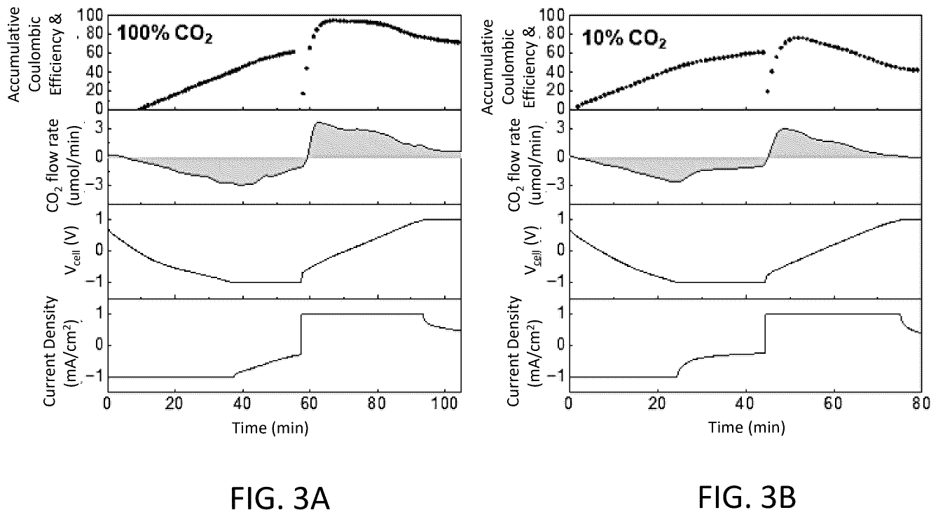

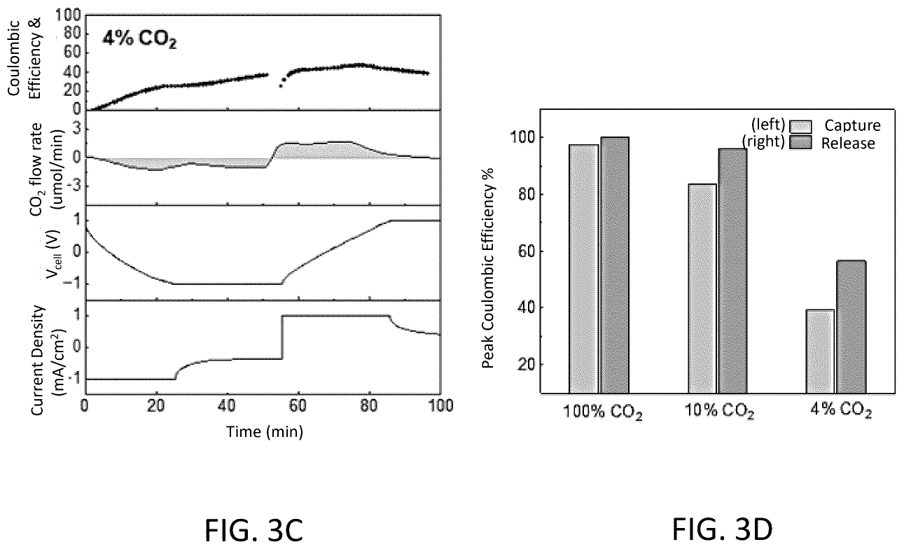

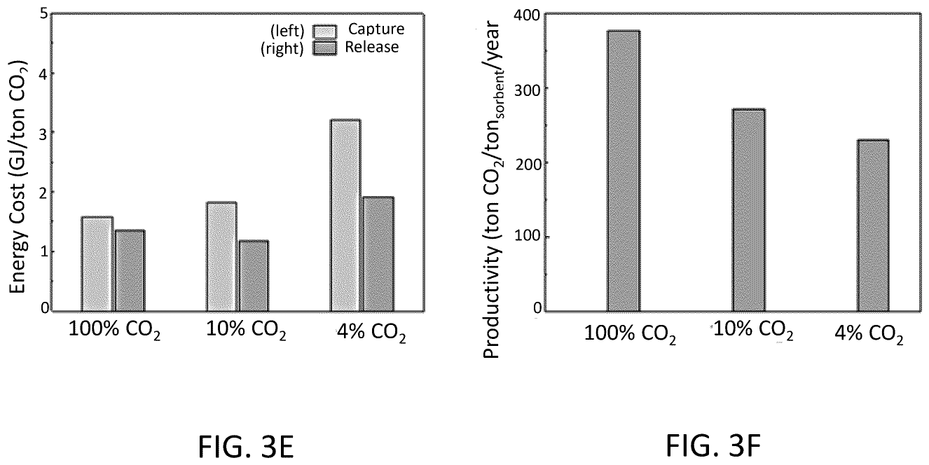

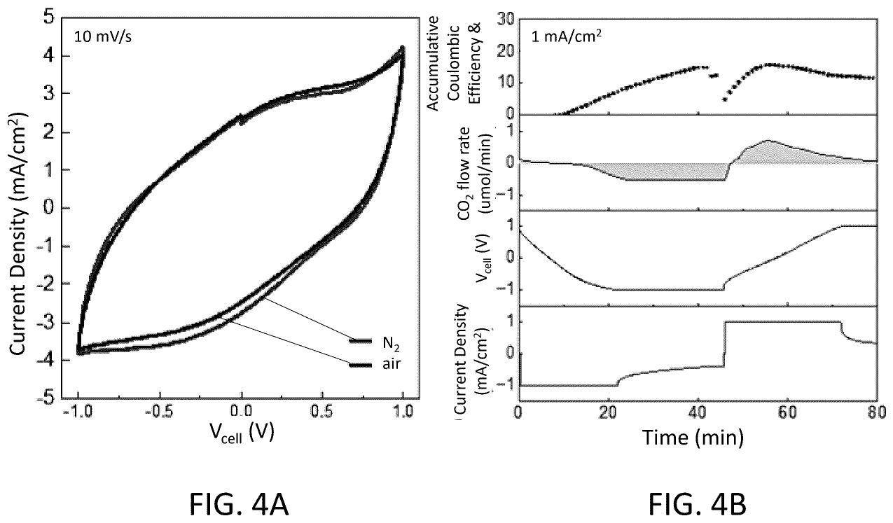

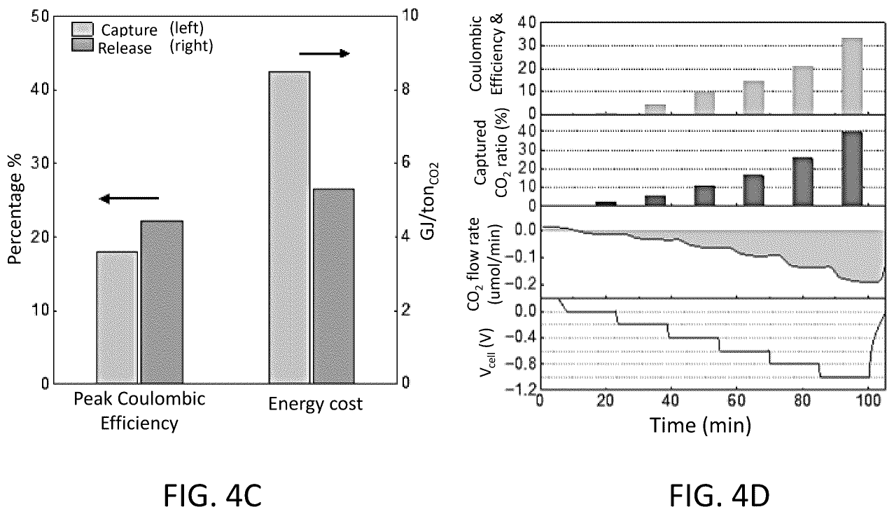

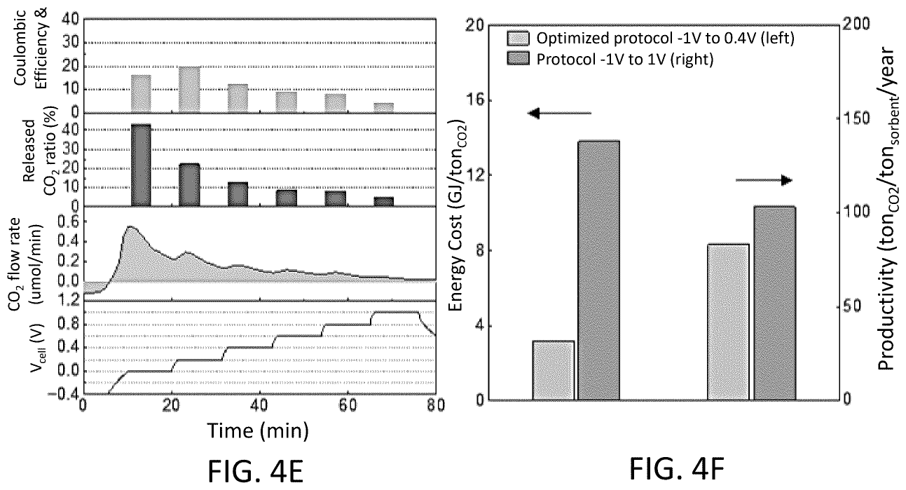

The present methods and systems may be characterized by various properties including high peak Coulombic efficiency (e.g., at least 15%, at least 25%, at least 50%, at least 75%), low energy cost (e.g., no more than 10 GJ/ton CO₂, no more than 5 GJ/ton CO₂, no more than 2 GJ/ton CO₂), high productivity (e.g., at least 40 ton CO₂/ton metal oxide/year, at least 60 ton CO₂/ton metal oxide/year, at least 80 ton CO₂/ton metal oxide/year) for either CO₂ capture or CO₂ release. (See FIGS. 3D-3F, 4C-4F.) These values may refer to specific operating conditions, e.g., a certain amount of CO₂ in the gas feed; use of air as the gas feed; a certain electrical bias; and/or a certain current density.

### Example

### Methods and Materials

### Materials

Manganese (II) sulfate monohydrate (ReagentPlus, ≥99%), potassium permanganate (ACS reagent, ≥99.0%), sodium sulfate (ACS reagent, ≥99.0%, anhydrous, powder), sodium phosphate dibasic (ACS reagent, ≥99.0%), sodium hydroxide (98-100.5%), Gold (III) chloride trihydrate (>99.9%), citric acid (>99.0%), methanol (99.8%), were all purchased from Sigma-Aldrich without further treatment. Freudenberg H23C3, H23, Piperion membrane (40 μm) were purchased from Fuel Cell Store. Nafion® perfluorinated resin solution (D520), Nafion 212, Nafion 117 membrane were purchased from Ion power. The Ag/AgCl reference electrodes used in flow cell were purchased from CHI Instruments, Inc. Gascous CO₂ (research grade), N₂ (ultrahigh purity), Ar (ultrahigh purity) was purchased from Airgas. Ultrapure water (18.2 M (2 from MilliQ) was used to prepare all the solutions and electrolytes.

### Synthesizing a Metal Oxide Electro-Sorbent (MnO₂)

A typical synthesis included mixing 120 ml 0.2 mol/L MnSO₄ solution and 80 ml 0.2 mol/L KMnO4 solution under stirring in a 325 ml glass vial. The mixture was then stirred for 10-30 min at room temperature. The brown MnO₂ precipitate was collected by centrifuge, washed several times with water, and vacuum dried. This synthesis process can also be conducted in a larger container with scaled quantity of the precursors mentioned above.

### Synthesis of 55 nm Au@MnO₂ NPs for Surface-Enhanced Raman Spectroscopy (SERS) Tests

Au NPs were synthesized by adding 2.537 mL of a 0.863 wt % HAuCl4 aqueous solution into 200 mL of ultrapure water in a 250 mL round-bottom flask. The solution was then heated to boiling, followed by adding 1.5 mL 1% citric acid (CA) solution. Then, the mixture continued boiling for 30 minutes, and cooled naturally to obtain the Au NPs solution.

Au@MnO₂ core-shell nanoparticles were then synthesized by taking 10 ml of the prepared Au NPs solution, and adding 170 mL of 0.1 M KOH, 0.5 mL of 0.01 M KMnO₄, and 2.5 ml of 0.01 M MnSO₄ or K₂C₂O₄ as reduction agent. The mixture was placed in an ice bath for 60 minutes to ensure complete reaction.

Fabricating an eCO₂-MDCR Device

To fabricate the electrode for a 5 cm² eCO₂-MDCR device, 150 mg MnO₂ powder obtained from above was dispersed in 7 ml methanol and then mixed with 15 mg conductive carbon black powder (e.g., Vulcan XC72) and 300 mg polymer binder (e.g., Nafion 521). After sonication, a homogeneous ink was obtained and then coated on two 5 cm² gas diffusion layers (e.g., carbon paper). The eCO₂-MDCR device may be assembled by attaching the two electrosorbent coated electrodes to each side of a separator membrane to form a membrane-electrode-assembly (MEA), which is then positioned in between two current collector plates.

As shown in FIG. 6A, the device can be assembled in an asymmetric way, in which one side of the device is connected with gas (CO₂, N₂, CO₂/N₂ mixture, or air), and the other side is connected with electrolyte (e.g., 0.5 mol/L Na₂SO₄). The side with gas feeding is considered to be the working electrode for evaluating the CO₂ capture and release performance and the side with electrolyte feeding is considered to be the counter electrode to balance the current and to provide electrolyte to ensure sufficient ionic conductivity. This is the configuration used in the Results and Discussion section below.

However, the device can also be assembled in a symmetric way as shown in FIG. 6B, in which both sides of the device may be connected with gas feed for CO₂ capture and release, and the electrolyte can be positioned in between the two electrodes. In this device architecture, while one electrode is undergoing reduction to mineralize and capture CO₂, the other electrode will be oxidized to demineralize and release CO₂. As a result, the symmetric eCO₂-MDCR device will reduce the overall energy cost for CO₂ capture and release by half.

### Electrochemical Measurement

Electrochemical measurements were all conducted using a BioLogic VSP300 potentiostat. Gases (N₂, CO₂, house air) were supplied to the working electrode by mass flow controller (Alicat Scientific). The gas flow was controlled to be a low flow rate around 30 sccm, since a high flow rate would result in a high pressure drop in practical gas contactor, which would cost considerable amount of fan energy. The change of pressure during the electrochemical testing was monitored in separate tests using a pressure transducer (Alicat Scientific) with the inlet and outlet valves closed. The concentration of the CO₂ from the outlet of the device was measured by a CO₂ analyzer (T360M, Teledyne). To sustain the required gas flow rate (>700 ml/min) for the CO₂ analyzer, the gas flow from the device outlet was diluted with Ar flow (˜690 sccm) to ensure sufficient gas supply. Before testing, the CO₂ analyzer was calibrated with Ar UHP to set the zero point, and with diluted CO₂ to check the accuracy of concentration measurement. The concentration of the CO₂ in the house air was measured to be around 435 ppm. The pH of the electrolyte was monitored by a pH meter (Oakton PC450), and the pH was buffered to be around 7 (neutral condition). For device activation, cyclic voltammetry experiments were conducted between-1V and IV at 10 mV/s and 50 mV/s under stabilization. For CO₂ capture and release protocol, the device was charged and discharged at various constant current densities (typically 1 mA/cm²) until the cell voltage reached the set values and held at the set values for a set period of time. All voltages were reported in full-cell voltage without any iR compensation.

### CO₂ Capture and Release Measurement

The amount of CO₂ being captured or released during an electrochemical cycle was calculated by integrating the CO₂ flow rate corresponding with the capture or release cycle. The CO₂ flow rate was calculated by the CO₂ concentration difference between the measured value and the baseline concentration of the supplied gas (Eq. S1). The measured C_{CO2, measure} is the concentration of CO₂ in the gas flow into the analyzer; C_{CO2, baseline} is the concentration of CO₂ in the feeding gas to the device, the f_{analyzer} is the flow rate supplied into the analyzer. The conversion from volumetric flow rate (L/min) to molar flow rate (mol/min) is calculated by the ideal gas law.

$$\begin{matrix}{CO}_{2} flow rate ( \frac{mol}{min} ) = \{ {c}_{CO 2 , measured} - {c}_{CO 2 , measured} \} ( \% ) \times {f}_{analyzer} ( \frac{L}{min} ) \times \\ \frac{101 ( kPa )}{8.314 ( J / mol \cdot K ) \times 293.15 ( K )}\end{matrix} \qquad ( Eq . S 1 )$$

The columbic efficiency (Eq. S2) and energy cost (Eq. S3) were calculated by normalizing the integrated charge (Q) and energy (E) of the electrochemical process from the initial point (tᵢ) to the final point (t_{f}) with the corresponding quantity of CO₂.

$$Columbic efficiency ( \% ) = \frac{{\int }_{ti}^{tf} {CO}_{2} flow rate \cdot dt}{{\int }_{ti}^{tf} Q \cdot dt} \qquad ( Eq . S 2 )$$

$$Energy cost ( GJ / {ton}_{CO 2} ) = \frac{{\int }_{ti}^{tf} E \cdot dt}{{\int }_{ti}^{tf} {CO}_{2} flow rate \cdot dt} \qquad ( Eq . S 3 )$$

The productivity that reflects the capture and release kinetics was calculated by normalizing the amount of CO₂ released in a complete cycle by the weight of the applied sorbent materials (w_{sorbent}) and the duration of the complete capture and release cycle (t_{cycle}), as shown in Eq.S4.

$$Productivity ( {ton}_{CO 2} {ton}_{sorbent}^{- 1} {year}^{- 1} ) = \frac{{\int }_{ti}^{tf} {CO}_{2} flow rate \cdot dt}{{w}_{sorbent} {t}_{cycle}} \qquad ( Eq . S 4 )$$

### Materials Characterization

TEM images were taken using a JEOL GrandArm 200 microscope at an acceleration voltage of 200 kV. A probe convergence angle of 20 mrad was used. The XRD measurements were conducted on a STOE STADI MP diffractometer using Mo or Ag K-α radiation (λ_{Ag}=0.056 nm, λ_{Mo}=0.071 nm).

### Operando Raman Spectroscopy

The operando electrochemical surface-enhanced Raman spectroscopy (SERS) measurements were carried out using a PGSTAT204 electrochemical workstation coupled with a RENISHAW in Via confocal Raman microscope. The wavelength utilized in the experiment was 633 nm. A custom-designed Raman cell was employed, featuring a platinum wire as the counter electrode and an Ag/AgCl electrode as the reference electrode. Core-shell Au@MnO₂ nanoparticles were coated on carbon paper and used as the working electrode

### Results and Discussion

### Proof-of-Concept and Mechanism

As an initial step, characteristics of an ideal electrochemical capture and release metal oxide sorbent were considered. First, it is desirably redox active in near-neutral conditions, where the reduction reaction would create active electron-rich oxygen at the metal oxide surface as nucleophilic sites to react with CO₂. Second, to be able to operate in aqueous system, desirable metal oxides include those that, in neutral conditions, have a redox potential window having minimum overlap with side reactions such as water dissociation and oxygen reduction. Finally, to ensure stability of the capture and release electrode, the redox reactions should take place in the solid phase. In other words, the active electrode materials desirably do not dissolve in the near-neutral conditions during the redox cycling. MnO₂, which has good redox behavior under neutral conditions, was selected as it fulfills all the requirements based on the Pourbaix diagram analysis (FIG. 1C). DFT simulations revealed that the CO₂ capture and release could be controlled by the potential at the MnO₂ surface with a crossover potential at around 0.7 V vs. RHE (FIG. 1D).

A membrane-electrode-assembly system was employed in which the manganese oxide electrosorbent was coated on both sides of a membrane to build an asymmetric electrified CO₂ mineralization/demineralization capture/release (eCO₂-MDCR) device shown in FIG. 2A (see also FIG. 6A). While both sides of the device can conduct CO₂ capture and release, the performance from one side of the device was analyzed as the working electrode, and the other side was used as the counter electrode and the electrolyte reservoir. In a typical testing cycle, the working electrode with electrosorbent first undergoes a reduction reaction with CO₂ being captured from the input gas stream, then the cell voltage is switched to drive oxidation reaction and the captured CO₂ is released. (See the chemical reactions shown in the right image of FIGS. 1A and 1n FIGS. 2C-2D.) The quantity and rate of CO₂ being captured or released were calculated from a CO₂ analyzer (data not shown).

The concept of the eCO₂-MDCR device was first validated under an ideal pure CO₂ condition. First, cyclic voltammetry (CV) was performed, and the cell voltage was scanned at 10 mV/s between-1V to IV. A consistent and highly voltage-dependent CO₂ capture and release behavior was observed (FIG. 2B): when the cell was scanned towards-1V, the CO₂ was captured, and when scanned towards 1V, the CO₂ was released. In addition, the CO₂ capture and release kinetics could be tuned by controlling the charging rate. By increasing the charging rate from 1 to 4 mA/cm², the maximum CO₂ capture and release rate also increased from ca. 3 to 10 μmol/min (data not shown). These results demonstrate that the eCO₂-MDCR device offered fast-response and tunable CO₂ capture and release under various operating conditions, enabling its coupling with an intermittent renewable energy source.

Next, an Operando Raman spectroscopy study was conducted with a gas-diffusion-electrode cell under ambient air to investigate the CO₂ capture and release mechanism (FIGS. 2C and 2D and other data not shown). To simulate the capture process, the potential was scanned from 1.0V to 0.1V vs. reversible hydrogen electrode (RHE). Notably, a clear set of bicarbonate (—OCO₂H) characteristic peaks at 1007 cm⁻¹ and 1376 cm⁻¹ was observed at 0.7V vs. RHE when the MnO₂ started to reduce to MnOOH, and the peak intensity gradually increased when the potential was decreased to 0.4V. The potential dependent change in peak intensity suggests that the —OCO₂H was bonded to the surface of manganese oxide. Interestingly, the typical characteristic peak of Mn—OH at around 830 cm⁻¹ (data not shown) was not observed with the presence of CO₂ (FIGS. 2C and 2D, shaded area). These results support the hypothesis that it is the surface mineralized Mn—OCO₂H is present instead of Mn—OH. This is further supported by the fact that the reduction intermediate, Mn—O—, is highly nucleophilic.

To further support this hypothesis, DFT calculations were conducted. It was found that under decreasing potential, the Mn—O⁻ intermediate was more likely to react with CO₂ to form Mn—OCO₂H, versus reacting with H₂O to form Mn—OH. This is consistent with the Operando Raman spectroscopy results (data not shown). With further decreasing potential, the —OCO₂H peak started to decrease while the intensity of the carbonate (Mn—OCO₂⁻) characteristic peak at 1065 cm⁻¹ increased indicating the pH-dependent equilibrium between bicarbonate and carbonate. To simulate the release process, the potential was scanned back from 0.1V to 1.0V. A reverse of the capture process was observed. Specifically, as the Mn—OCO₂⁻ ″ peak decreased, the Mn—OCO₂H peak increased when the potential was scanned from 0.1V to 0.4V. The Mn—OCO₂H peak gradually decreased when the potential was scanned to 1.0V, at which point the MnO₂ was regenerated.

These Operando Raman spectroscopy and DFT simulation results support a reversible CO₂ mineralization mechanism, driven by the electrochemical redox reactions of manganese oxide, i.e., a new inorganic CO₂ capture and release mechanism. This mechanism is further supported by the increase in the redox current density during the CV scans with increasing CO₂ concentration in the feed gases and buffered electrolyte pH (data not shown).

### Performance Evaluation in Flue Gas Capture

The performance of the eCO₂-MDCR device was then evaluated under more practical conditions in addition to the ideal 100% CO₂ condition (FIG. 3A), including 10% CO₂ (FIG. 3B) and 4% CO₂ (FIG. 3C) balanced with N₂ to simulate the typical CO₂ concentration level from coal plants and natural gas combined cycle power plants, respectively. A protocol with a charging rate of 1 mA/cm² between-1V and IV was adopted to evaluate the CO₂ capture and release performance. During the initial capture process, the CO₂ was captured at an increasing capture rate, which reached a maximum of around 2.6 μmol/min, and 1.2 μmol/min for 10% (FIG. 3B), and 4% CO₂ (FIG. 3C), respectively, when the cell voltage approached-IV. During the release process, it was found that the CO₂ was released at a higher rate as compared to the capture process, with maximum release rate of over 3.0 μmol/min for 10% and 1.8 μmol/min for 4% CO₂. Interestingly, the peak coulombic efficiency for the capture and release process reached nearly 100% for pure CO₂, over 80% (84% for capture and 96% for release) for 10% CO₂, and over 40% (40% for capture and 57% for release) for 4% CO₂ (FIG. 3D). The energy cost for the electrochemical capture and release process was calculated by normalizing the energy consumption with the quantity of the CO₂ being captured or released (FIG. 3E). The results showed that the capture process consumed 1.8 and 3.2 GJ/ton_{CO2}, for 10% and 4% CO₂. Notably, the energy cost for releasing the CO₂ was similar compared to the capture process, at 1.2 GJ/ton_{CO2} and 1.9 GJ/ton_{CO2} for 10% and 4% CO₂, respectively. This is because the CO₂ had been mineralized and concentrated on the electrosorbent's surface.

While only one side of the electrode was analyzed in the lab setup, the total energy costs would be further reduced by half as the redox reaction at the counter electrode can also perform CO₂ capture and release (data not shown). Therefore, the present methods and systems provide a path to reducing energy costs to roughly 1.5 GJ/ton_{CO2} and 2.5 GJ/ton_{CO2} for 10% and 4% CO₂, respectively. The CO₂ capture kinetics of the developed device can be considered by reference to productivity, which is defined as the quantity of CO₂ being captured per ton of sorbent per year. From a practical perspective, a higher productivity translates to lower usage of materials, which would greatly reduce the capital cost of a direct air capture facility. The analysis showed that the productivity was roughly 270 and 230 ton_{CO2}/ton_{MnO2}/year for capturing from 10% and 4% CO₂ feedstock (FIG. 3F), respectively. This corresponds to a sorbent material capital cost of only 3.7M and 4.3M USD$ for a plant that is required to capture 1 Mton_{CO2}/year, given the low MnO₂ cost. This energy cost is among the lowest of existing technology for flue gas capture, and it provides a cheap and flexible carbon capture solution to directly couple with intermittent renewable energy sources.

### Performance Evaluation in Direct Air Capture

Directly capturing CO₂ from air has been an extremely challenging task given the ultralow CO₂ concentration (around 0.04%) and oxygen sensitivity to oxygen. In addition, the water in ambient air can compete with CO₂ for active sites. There is also a cost for extra regeneration energy for thermal-regenerated solid sorbent systems. To demonstrate the capability of the eCO₂-MDCR device, the performance under air with only 0.04% CO₂ (and around 21% O₂) was evaluated. First, the oxygen tolerance of the eCO₂-MDCR device was evaluated by performing cyclic voltammetry (CV) scan under N₂ and air flow (FIG. 4A). The almost identical CV curves clearly demonstrates that there was no interference from the oxygen reduction reaction within the operating voltage range. Next, the DAC performance was evaluated with a charging rate of 1 mA/cm² between-1V and IV. Similar to the observed trend in flue gas capture, the CO₂ was captured at an increasing capture rate, which reached the maximum of around 0.6 μmol/min when the cell voltage approached-IV (FIG. 4B). Then, when the cell voltage was scanned towards IV, a fast CO₂ release was observed with a maximum rate of around 0.7 μmol/min (FIG. 4B). The peak coulombic efficiency approached 18% and 22% for capture and release, respectively, resulting in energy costs of 8.5 GJ/ton_{CO2} and 5.4 GJ/ton_{CO2} for capture and release, respectively (FIG. 4C). The relatively low coulombic efficiency and high energy cost as compared to flue gas capture were attributed to the challenging low concentration of CO₂ in air, which limited the quantity of CO₂ being captured within a reasonable period of time (affecting productivity) and air flow rate (affecting pressure drop). These challenges can be mitigated by optimizing capture and release protocols as described below.

To probe a suitable capture and release protocol for DAC with the eCO₂-MDCR device, the impact of charging rate was first evaluated (data not shown). It was found that with a slow charging rate of 0.5 mA/cm², a slightly higher total capture coulombic efficiency of 15.8% was obtained as compared to 14.5% for 1 mA/cm², suggesting the importance of matching the CO₂ capture and supply rate (data not shown). In addition, the total energy cost for the whole cycle charging at 0.5 mA/cm² was found to be 12.1 GJ/ton, which is lower than the 13.9 GJ/ton for charging at 1.0 mA/cm² (data not shown). While the slower charging rate enabled higher efficiency and lower energy costs, the longer cycle duration impacted the CO₂ capture rate and thus productivity (data not shown). Nevertheless, the ability to tune CO₂ capture performance of the eCO₂-MDCR device enables the device to readily match demand in various operation scenarios.

Next, to probe the optimum operating voltage window for CO₂ capture and release, a stepped capture and release experiment was performed, in which the cell voltage was scanned and held every 0.2V between-1V and IV (FIGS. 4D and 4E). Interestingly, during the capture process, it was found that the average capture coulombic efficiency increased with decreasing voltage, reaching the maximum of 33% during the hold at −1V and contributing to over 40% of the total captured CO₂ quantity (FIG. 4D). On the other hand, during the release process, the peak release coulombic efficiency of 20% was achieved at 0.2V, while around 80% of CO₂ was released at 0.4V (FIG. 4E). Based on these results, an optimized CO₂ capture and release protocol was derived, which captured CO₂ at −1V and stepped released CO₂ towards 0.4V. This optimized protocol offers a low energy cost of 3.2 GJ/ton_{CO2} for DAC (FIG. 4F, left axis), nearly 60% lower than traditional DAC technologies and could potentially lowered to 1.6 GJ/ton_{CO2} by also utilizing the counter redox reaction. In addition, despite the low energy cost, the optimized protocol did not substantially sacrifice the capture and release kinetics, with a peak capture and release rate around 0.01 mmol_{CO2} g⁻¹ min⁻¹ (data not shown). The capture and release kinetics is also reflected by the relatively high productivity of 83 ton_{CO2}/ton_{MnO2}/year (FIG. 4F, right axis). This translates to a low sorbent material capital cost of only 12M USD$ for a DAC plant required to capture 1 Mton_{CO2}/year, making it a highly attractive solution for low-cost DAC application.

### Durability Evaluation in Direct Air Capture

A key criterion for DAC applications is system durability, which strongly affects the lifetime-averaged cost (levelized cost) of the DAC technology. The presence of O₂ poses great durability challenges for most organic-based technologies (e.g., peroxide formation between reduced quinones and O₂), and these challenges are exacerbated in DAC because the O₂ concentration is over 500 times that of CO₂. Thus, the DAC durability of the eCO₂-MDCR device was evaluated by continuously running complete DAC capture and release cycles (roughly 1.4 hours per cycle). It was found that the eCO₂-MDCR performance was stable over 200 hours of continuous cycling operation (FIG. 5), and the oxygen tolerance stayed intact (data not shown). The ratio of CO₂ release and capture gradually reached 100%, indicating that all captured CO₂ was released in a stable operation when the system reached equilibrium. In addition, it was found that despite the CV capacitance showing some degradation after continuous voltage cycling, the degradation was primarily due to the loss from the electrolyte immersed counter electrode. The CV capacitance was fully recovered when the counter electrode was replaced (data not shown), at which point the DAC performance equilibrated and was maintained for an additional 100 hours. Structural characterization showed that the major structural features of the electrosorbent material were still present (data not shown). In summary, the eCO₂-MDCR device demonstrated a stable DAC performance durability over 290 hours without noticeable performance loss, highlighting its capabilities in electrifying DAC applications.

### CONCLUSIONS

In summary, this Example reports the performance of an illustrative eCO₂-MDCR device which is believed to operate via a new mechanism as shown using Operando Raman spectroscopy. The device provides an inorganic electrochemical pathway to address the persisting challenges of cost, energy consumption, and durability in carbon capture, particularly direct air capture.

Additional information, including the data/information indicated as not being shown may be found in U.S. provisional patent application No. 63/639,088 that was filed Aug. 1, 2024, the entire contents of which are incorporated herein by reference.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

Unless otherwise indicated, and in recognition of the inherent nature of the techniques described herein, throughout the present disclosure, terms and phrases such as “absence,” “free,” “does not comprise,” etc. encompass, but do not require a perfect absence of the referenced entity.

Unless otherwise indicated, the term “type” as used herein refers to chemical formula such that a single type means the same chemical formula and different type means different chemical formula. Similarly, use of “more” as in “one or more types” refers to use of different types of the relevant entity.

Unless otherwise indicated, throughout the present disclosure, terms such as “comprising” and the like may be replaced with terms such as “consisting” and the like.

1. A method comprising delivering CO₂ to a first electrode of an electrochemical cell, the first electrode in electrical communication with a second electrode and the first electrode comprising an electrosorbent material free of carbon atoms and comprising a metal; and applying a first electrical bias to the first electrode to induce a reduction reaction to capture the CO₂ on surfaces of the electrosorbent material.

2. The method of claim 1, wherein the electrosorbent material is redox active at neutral pH and over a range of electrode potentials at which an electrolyte in the electrochemical cell does not undergo redox reactions, and further wherein the reduction reaction occurs in a solid phase.

3. The method of claim 1, wherein the CO₂ is captured by a binding moiety of the electrosorbent material, the binding moiety comprising the metal in its reduced form and covalently bound to an oxygen atom having an unpaired electron.

4. The method of claim 1, wherein the electrosorbent material is a metal oxide.

5. The method of claim 4, wherein the metal of the metal oxide is selected from Mn, Ti, V, Cr, Ni, Co, Cu, Fe, and combinations thereof.

6. The method of claim 4, wherein the transition metal oxide is MnO₂.

7. The method of claim 1, further comprising either applying a second electrical bias to the first electrode to induce an oxidation reaction to release captured CO₂ from the surfaces of the electrosorbent material of the first electrode; or applying the second electrical bias to the second electrode of the electrochemical cell, the second electrode comprising an electrosorbent material free of carbon atoms and comprising a metal, to induce an oxidation reaction to release captured CO₂ from surfaces of the electrosorbent material of the second electrode.

8. The method of claim 7, wherein the electrosorbent material of the first electrode and the electrosorbent material of the second electrode are the same type of electrosorbent material.

9. The method of claim 1, wherein the CO₂ is delivered at an amount of less than 1% by volume.

10. The method of claim 1, wherein the CO₂ is in air delivered to the first electrode.

11. The method of claim 1, wherein the electrochemical cell further comprises an electrolyte in contact with the first and second electrodes and the electrolyte is at neutral pH.

12. The method of claim 7, wherein the CO₂ is captured at a pH, at a temperature, and at a pressure, and the CO₂ is released at the same pH, at the same temperature, and at the same pressure.

13. The method of claim 7, wherein no feed gas, other than a feed gas to deliver CO₂, is used to release captured CO₂.

14. The method of claim 1, wherein the electrochemical cell comprises one or more separators positioned between the first and second electrodes.

15. The method of claim 14, wherein the one or more separators are not bipolar membranes and are not anion exchange membranes.

16. The method of claim 14, wherein the electrochemical cell comprises one separator between the first electrode and the second electrode, a gas inlet for delivery of the CO₂ to the first electrode, an electrolyte inlet for delivery of the electrolyte to the second electrode, and a gas outlet for release of CO₂ from the first electrode.

17. The method of claim 14, wherein the electrochemical cell comprises a first separator and a second separator positioned between the first and second electrodes and defining a channel therebetween, a gas inlet for delivery of CO₂ to the first electrode, an electrolyte inlet for delivery of the electrolyte to the channel, and a gas outlet for release of CO₂ from the second electrode.

18. An electrochemical cell configured to capture and release CO₂, the electrochemical cell comprising:
a first electrode comprising an electrosorbent material free of carbon atoms and comprising a metal;
a second electrode in electrical communication with the first electrode, the second electrode comprising the electrosorbent material;
one or more separators positioned between the first and second electrodes; and
a protic electrolyte at neutral pH in fluid communication with the first and second electrodes.

19. The electrochemical cell of claim 18, wherein the one or more separators are not bipolar membranes and are not anion exchange membranes.

20. The electrochemical cell of claim 18, wherein the electrosorbent material is a metal oxide and the metal of the metal oxide is selected from Mn, Ti, V, Cr, Ni, Co, Cu, Fe, and combinations thereof.
